(19) United States
(12) Patent Application Publication
(10) Pub. No.: US 2026/0298870 A1
(43) Pub. Date: Oct. 1, 2026

(54) CAPILLARY ARRAY FABRICATION METHODS

(71) Applicant: AGILENT TECHNOLOGIES, INC., Santa Clara, CA (US)

(72) Inventors: Paul GRIESZ, Karlsruhe (DE); Ansgar WALDBAUR, Waldbronn (DE)

(73) Assignee: AGILENT TECHNOLOGIES, INC., Santa Clara, CA (US)

(21) Appl. No.: 19/489,096

(22) PCT Filed: Jun. 2, 2023
(86) PCT No.: PCT/US2023/024362

§ 371 Date: Dec. 1, 2025

(51) Int. Cl. G01N 27/453; G01N 27/447; G01N 30/60

(52) U.S. Cl. CPC G01N 27/453; G01N 27/44704; G01N 30/6078

(57) ABSTRACT

A capillary array assembly is fabricated by inserting capillaries into respective grooves of a substrate and fixing the capillaries to the substrate. The capillaries are fixed by applying heat and force to the substrate, with a defined displacement of substrate material and for a defined period of time, thereby spreading heated portions of the substrate over the capillaries. After applying the heat and force, capillaries are at least partially embedded by the substrate and may be at least partially exposed to a top outside surface of the substrate by respective slots. The capillary array assembly may be utilized, for example, in a sample analysis instrument such as a capillary electrophoresis (CE) instrument.

### TECHNICAL FIELD

The present invention relates to capillary array assemblies and methods for fabricating such capillary array assemblies. The invention also relates to devices, systems and the like that include or operate with such capillary array assemblies. The capillary array assemblies may be utilized, for example, as part of analytical techniques such as capillary electrophoresis (CE).

### BACKGROUND

Analytical instruments often utilize capillaries (i.e., tubes with bores on the scale of micrometers) to contain and transport sample-containing fluids (in either liquid phase or gas phase) for various purposes. In some analytical instruments, a capillary may be configured to perform analytical separation of analytes of a sample (i.e., sample components of interest such as chemical compounds or biological compounds) on the basis of different properties or attributes, such as molecular size, molecular composition, electrical charge, etc. For this purpose, the capillary may contain a separation medium in its inner bore. The separation medium may be a stationary phase that is permanently or semi-permanently located in the capillary. A semi-permanent phase may be a separation medium that requires periodic replacement or regeneration during the service life of the capillary. Depending on the analytical technique, the stationary phase may be a polymer gel, a packing of beads, a monolithic material with interstices allowing fluid flow, a lining or film on the inside surface of the capillary that defines its inner bore, etc. Alternatively, the separation medium may be a dynamic phase that requires more frequent replacement or regeneration, such as after each analytical run or even during the same analytical run. In use, the sample is carried by a fluid (i.e., a mobile phase) through the capillary and into contact with the separation medium. As the sample migrates through the separation medium, different analytes of the sample become separated from each other, thereby facilitating detection/measurement of the analytes by the analytical instrument. Examples of analytical separation techniques include capillary electrophoresis (CE, e.g., capillary gel electrophoresis or CGE, capillary zone electrophoresis or CZE, etc.), liquid chromatography (LC), and gas chromatography (GC).

In some analytical instruments, a capillary—or at least an optically transparent section of a capillary, referred to as a capillary window—may be utilized as sample detection cell. In this case, the analytical instrument is configured to make optical-based measurements (e.g., fluorescence, absorbance, imaging, etc.) of sample analytes contained in the capillary by reading electromagnetic energy emitted from the sample. Such emission may be in response to the sample being irradiated by a beam of electromagnetic energy directed to the capillary window by an electromagnetic radiation source of the analytical instrument. This type of detection/measurement, which may be referred to as on-capillary detection, is done after the analytes have been separated in the capillary but while the analytes still reside in the capillary. Alternatively, the outlet end of the capillary may extend into a flow cell, and the fluid containing the separated analytes is emitted from the outlet end into the flow cell. In this latter case, the detection optics (e.g., source and detector of electromagnetic energy) may interact with the analyte-bearing fluid stream emitted from the capillary.

Sample analysis (i.e., both analytical separation and detection/measurement) may be enhanced by operating multiple capillaries in parallel and simultaneously during the same analytical run. Besides increasing analytical throughput, multi-capillary systems can significantly increase the flexibility and variation in the development of analytical strategies. As examples, different samples may be loaded into different capillaries, and different analytes may be targeted in different capillaries. Moreover, an optical system may irradiate, and collect detection/measurement signals from, multiple capillaries simultaneously or sequentially as desired for a particular method development.

Multiple capillaries, or capillary arrays, have been utilized in analytical instruments. In the context of CE, see, e.g., U.S. Pat. Nos. 11,442,038 and 7,473,342; the entire contents of each of which are incorporated by reference herein. Known approaches employ capillary fixtures, i.e., structures configured to fix an array of capillaries in place relative to each other and/or relative to other components (e.g., electrodes coaxial with the capillaries, components of the analytical instrument, etc.). Disadvantages are associated with the known approaches. For example, the fixing of capillary arrays often requires the use of adhesives (glucs) such as in the form of adhesive-sided tapes or cured adhesive compounds and/or the use of components of differing compositions and thus differing properties. These approaches can result in outgassing of the adhesive/glue component that contaminates the samples or portions of the analytical instrument, unwanted fluorescence (e.g., autofluorescence) from the adhesive that increases background noise in the detection/measurement signals produced by the analytical instrument, problems caused by different thermal expansion coefficients of the adhesive and other materials, limited packing density of capillaries due to adhesive viscosity, degradation of the adhesive caused by incident electromagnetic radiation from the optical-based detection/measurement system, swelling of the adhesive, inhomogeneous chemical resistance of the adhesive and other materials, increased space required by the use of the adhesive, etc. Moreover, these approaches require an excessive amount of time, cost, operator/user training, and number of components required for the assembly of capillary fixtures. Further, the dependency on adhesives limits the types of materials, or coatings on materials, which may be employed in capillary fixtures, and creates rigorous requirements on the surface quality and cleanliness of components of capillary fixtures. As another example, while an adhesive is curing, the capillaries may move out of their intended positions within the fixture being assembled. Some known approaches embed the capillaries between two or more sheets of material that are laminated together. See, e.g., U.S. Pat. No. 6,562,214. Such approaches often rely on the use of adhesives for carrying out the lamination, and suffer from one or more of the same disadvantages just noted. Moreover, the laminated arrangement may be prone to delamination over time.

Therefore, there is an ongoing need to provide capillary arrays that overcome problems such as those just noted.

### SUMMARY

To address the foregoing problems, in whole or in part, and/or other problems that may have been observed by persons skilled in the art, the present disclosure provides methods, processes, systems, apparatus, instruments, and/or devices, as described by way of example in implementations set forth below.

According to an implementation of the present disclosure, a method for fabricating a capillary array assembly includes: providing a substrate composed of a thermoplastic material, the substrate comprising a substrate length, a substrate width, a substrate height, a top outside surface, and a plurality of grooves, wherein the grooves run along at least part of the substrate length, extend from the top outside surface into the substrate along the substrate height, and are spaced from each other along the substrate width; inserting a plurality of capillaries into the grooves, respectively; and fixing the capillaries to the substrate by: applying heat and force to the substrate for a fixing time effective to displace a portion of the substrate over the capillaries; and after the fixing time, removing the heat and force to stop the displacing, wherein, after the fixing, the displaced portion of the substrate hardens and at least partially overlies the capillaries such that the substrate at least partially embeds the capillaries.

In an implementation, the providing of the substrate comprises forming the grooves.

In an implementation, the substrate has a configuration according to at least one of: the substrate is a single-piece body; the substrate is a non-laminated body.

In an implementation, the fixing is done according to at least one of: the fixing is done without adding additional material to the substrate; the fixing is done without adding additional material to the capillaries; the fixing is done without utilizing an adhesive.

In an implementation, the capillaries each comprise an outermost capillary surface, and after the fixing, the substrate directly contacts the outermost capillary surface.

In implementations, for each capillary, the outermost capillary surface may be defined by one of: a bare capillary outside surface of the capillary; an outer protective layer coaxially surrounding at least a section of the capillary; an additional outer layer coaxially surrounding at least a section of the capillary, wherein the additional outer layer comprises an electrically conductive material or a thermally conductive material; an additional outer layer coaxially surrounding at least a section of the capillary, wherein the additional outer layer comprises a thermally conductive, non-stick material.

In an implementation, the grooves each have a bottom groove surface, the grooves each have an initial groove height defined between the bottom groove surface and the top outside surface prior to the fixing, and the initial groove height is greater than an outside diameter of the capillaries.

In an implementation, the initial groove height is in a range of 125% to 200% of the outside diameter of the capillaries.

In an implementation, the substrate comprises a plurality of groove dividers defining the grooves, the applying of heat and force comprises applying the heat and force to at least portions of the groove dividers, and the displaced portion of the substrate that at least partially overlies the capillaries comprises at least portions of the groove dividers.

In an implementation, the applying of heat and force comprises pressing a heated stamp onto the top outside surface.

In an implementation, the top outside surface comprises a non-flat shape, and the heated stamp comprises a contact surface shaped to conform to the non-flat shape.

In an implementation, the method further includes: before the pressing, positioning a sheet between the heated stamp and the top outside surface, wherein the sheet is composed of a thermally conductive, non-stick material effective to transfer the heat and the force from the heated stamp to the top outside surface. The method may further include: after the pressing, removing the sheet.

In an implementation, the capillaries each have an outside diameter in a range from 50 μm to 400 μm, and an inside diameter in a range from 0.5 μm to 200 μm.

In an implementation, after the fixing, the capillaries are spaced from each other along the substrate width by a capillary spacing, and the capillary spacing is according to at least one of: an outside diameter of the capillary plus 30 μm, wherein the outside diameter is in a range from 50 μm to 400 μm; an outside diameter of the capillary plus 30 μm or greater, wherein the outside diameter is in a range from 50 μm to 400 μm; in a range from 10 μm to 9000 μm; and in a range from 100 μm to 600 μm.

In an implementation, the fixing forms a plurality of slots running along at least part of the substrate length, and the capillaries are exposed to the top outside surface by the slots, respectively.

In an implementation, the slots each have a slot width along the substrate width, and the slot width is according to at least one of: the slot width is less than an outside diameter of the capillaries; the slot width is greater that an inside diameter of the capillaries, and closer to the inside diameter than to an outside diameter of the capillaries; the slot width is equal to or less than an inside diameter of the capillaries; the slot width is in a range from 0 μm to 300 μm; the slot width is in a range from 0 μm to 300 μm, and is less than an outside diameter of the capillaries.

In an implementation, the capillaries each have a lower capillary half and an upper capillary half defining a cross-section of the capillary in a transverse plane defined by the substrate width and the substrate height; after the fixing, the lower capillary half is fully embedded by the substrate; and after the fixing, the upper capillary half is partially embedded by the substrate.

In an implementation, the upper capillary half is defined by an outside surface area; the upper capillary half is partially embedded by the substrate by a percentage of the outside surface area being covered; and the percentage is in a range from 0% to 80%.

In an implementation, the capillaries comprise capillary windows, respectively; the capillaries are covered by outer protective layers, respectively, except at the capillary windows; and the capillary windows are positioned in the substrate in alignment with each other, and are exposed to the top outside surface.

In an implementation, after the fixing, along at least a portion of the substrate length, the displaced portions fully overlie the capillaries such that the substrate fully embeds the capillaries.

According to another implementation, a capillary array assembly is fabricated according to any of the implementations noted above.

According to another implementation, a capillary array assembly is fabricated according to any of the methods disclosed herein.

According to another implementation, a capillary array assembly includes one or more features of the implementations noted above.

According to another implementation, a capillary array assembly includes one or more features of any of the implementations disclosed herein.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is a perspective view of an example of a capillary array assembly according to an implementation of the present disclosure.

FIG. 2 is a perspective view of an example of a multi-well plate that may be utilized with a capillary array assembly as disclosed herein.

FIG. 3A is a cross-sectional or end view of an example of a capillary that may be part of a capillary array assembly according to an implementation of the present disclosure.

FIG. 3B is a perspective view of the capillary illustrated in FIG. 3A.

FIG. 4A is a cross-sectional or end view of another example of a capillary according to an implementation of the present disclosure.

FIG. 4B is a perspective view of the capillary illustrated in FIG. 4A.

FIG. 5A is a perspective view of an example of a capillary array assembly (or a portion thereof) according to another implementation of the present disclosure.

FIG. 5B is a top plan view of the capillary array assembly illustrated in FIG. 5A.

FIG. 5C is a cross-sectional elevation view or end view of the capillary array assembly illustrated in FIG. 5A.

FIG. 5D is an enlarged cross-sectional elevation or end view of a portion of the capillary array assembly illustrated in FIG. 5C.

FIG. 6A is a cross-sectional elevation view or end view of a blank substrate according to an implementation of the present disclosure.

FIG. 6B is a cross-sectional elevation view or end view of an intermediate structured substrate in which grooves have been formed in the blank substrate illustrated in FIG. 6A, according to an implementation of the present disclosure.

FIG. 6C is a cross-sectional elevation view or end view of the intermediate structured substrate illustrated in FIG. 6B after adding capillaries according to an implementation of the present disclosure.

FIG. 6D is a cross-sectional elevation view or end view of the intermediate structured substrate illustrated in FIG. 6C, illustrating the application of heat and force according to an implementation of the present disclosure.

FIG. 7 is a top plan view of an example of a capillary array assembly (or a portion thereof) according to another implementation of the present disclosure.

The illustrations in all of the drawing figures are considered to be schematic, unless specifically indicated otherwise.

### DETAILED DESCRIPTION

In this disclosure, all “aspects,” “examples,” “embodiments,” and “implementations” described are considered to be non-limiting and non-exclusive. Accordingly, the fact that a specific “aspect,” “example,” “embodiment,” or “implementation” is explicitly described herein does not exclude other “aspects,” “examples,” “embodiments,” and “implementations” from the scope of the present disclosure even if not explicitly described. In this disclosure, the terms “aspect,” “example,” “embodiment,” and “implementation” are used interchangeably, i.e., are considered to have interchangeable meanings.

In this disclosure, the term “substantially,” “approximately,” or “about,” when modifying a specified numerical value, may be taken to encompass a range of values that include +/−10% of such numerical value.

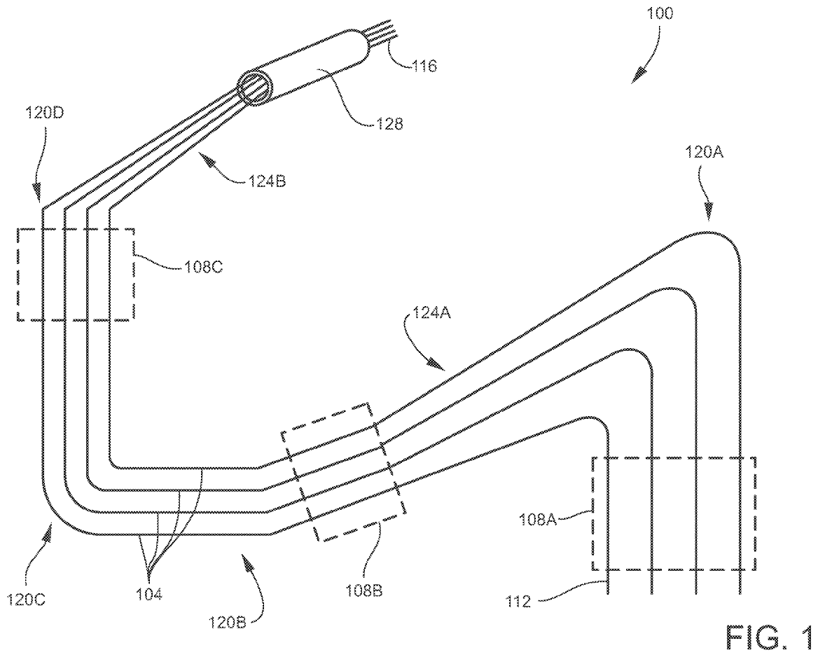

FIG. 1 is a perspective view of an example of a capillary array assembly 100 according to an implementation of the present disclosure. For simplicity, the capillary array assemblies disclosed herein will be described primarily in the context of capillary electrophoresis (CE), with the understanding that the capillary array assemblies may be utilized in applications outside CE.

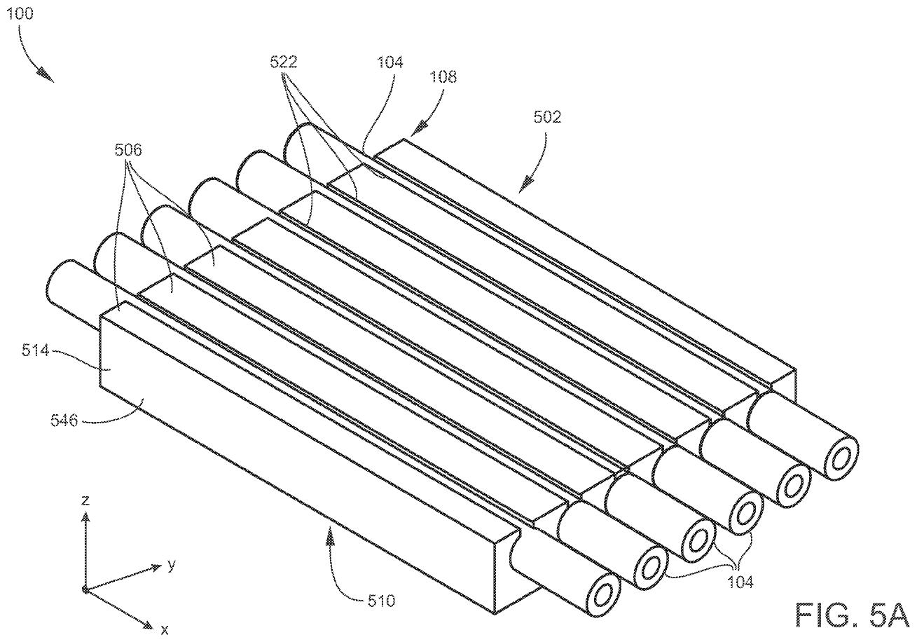

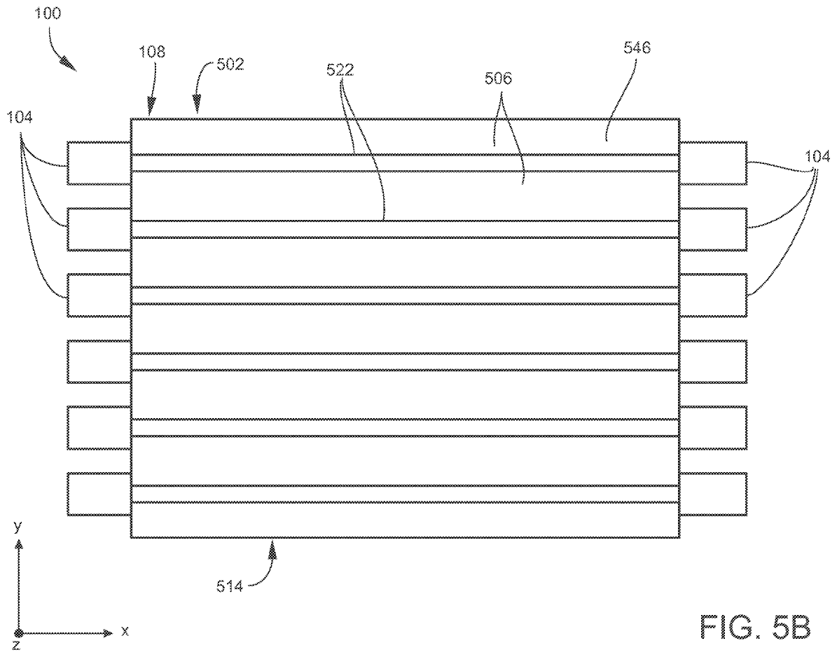

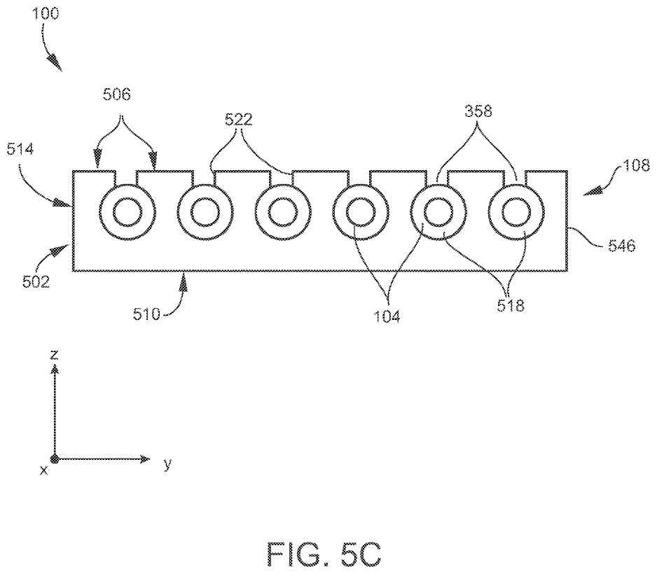

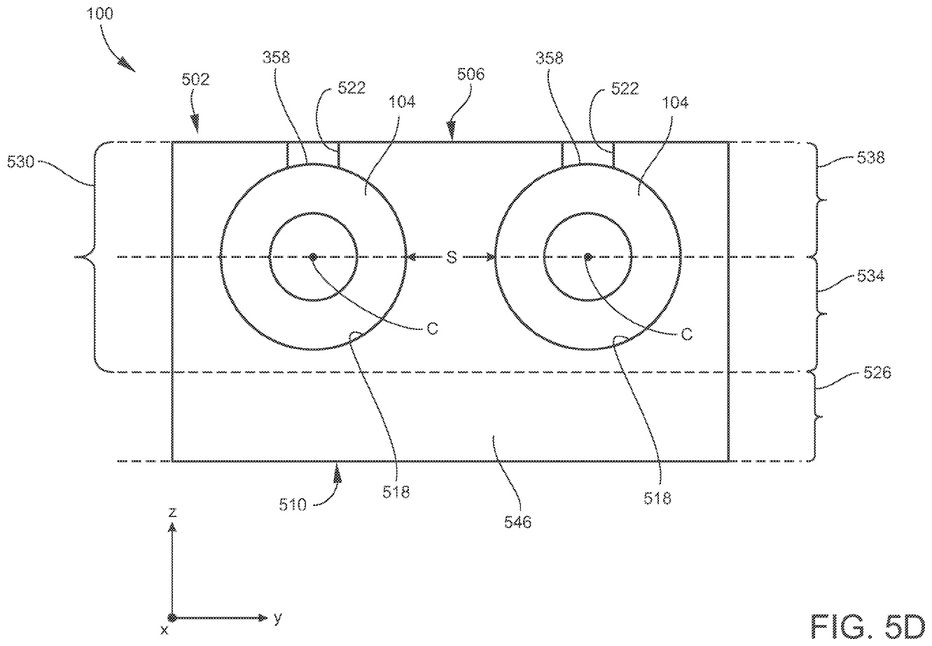

Generally, the capillary array assembly 100 includes a plurality of capillaries 104 and one or more capillary fixtures 108 to which the capillaries 104 are fixed. An example of one fixture 108 is described in more detail below in conjunction with FIGS. 5A-5D. Each fixture 108 is configured to securely hold or fix the capillaries 104 in a linear (one-dimensional or 1D) array, for example as a single row (or column) of capillaries 104. In the present context, the terms “securely hold” or “fix” mean that the capillaries 104 cannot be removed from the given fixture 108 while being utilized in a normal, intended manner (e.g., storage, transportation or carrying, installation in and removal from a CE instrument, operation with a CE instrument under cyclic operating conditions such as temperature, pressure, application of electric fields, etc.). For example, the amount of force required to pull any of the capillaries 104 out from the fixture 108 would be considered excessive in comparison to normal, intended use of the capillaries 104, and such excessive force may or may not be great enough to result in damage to the capillary 104 and/or the fixture 108.

FIG. 1 shows four capillaries 104 and three fixtures 108A, 108B, and 108C by example only. Generally, any number of capillaries 104 and fixtures 108A, 108B, and 108C may be provided, depending on the application (e.g., uses and functions). Multiple fixtures 108A, 108B, and 108C may be spaced apart from each other along the lengths of the capillaries 104.

Each capillary 104 has a capillary inlet end (or first end) 112, a capillary outlet end (or second end) 116, and a capillary length defined between and up to the capillary inlet end 112 and the capillary outlet end 116. Accordingly, the capillary array assembly 100 as a whole has an inlet end corresponding to the capillary inlet ends 112 and an outlet end corresponding to the capillary outlet ends 116. In the present context, the terms “inlet” and “outlet” are used as relative terms to distinguish the two opposite capillary ends from each other. For purposes of description, the capillary inlet ends 112 are taken to be the ends into which samples (e.g., sample solutions) are drawn (loaded) into the capillaries 104 in preparation for CE. However, in some applications, or at some stages of an application, a liquid may be drawn into the capillary outlet ends 116. Each capillary 104 may have a significant capillary length relative to its outer diameter (O.D.). As one example, the capillary length may be on the order of centimeters (cm), such as in a range from 20 cm to 300 cm. The capillary length may be great enough that the capillaries 104 need to occupy a significant amount of two-dimensional (2D) or three-dimensional (3D) space. For example, the capillaries 104 may be mounted in an interior chamber of a CE instrument. To reduce the overall 2D or 3D space (or form factor) occupied by the capillaries 104, the capillaries 104 may be bent at one or points along their lengths, for example at bends (bending locations) 120A, 120B, 120C, and 120D shown in FIG. 1.

In a CE application, the capillary inlet ends 112 may extend into an inlet-side liquid reservoir (not shown) and the capillary outlet ends 116 may extend into an outlet-side liquid reservoir (not shown). The capillary inlet ends 112 may be immersed in a liquid contained in the inlet-side liquid reservoir and the capillary outlet ends 116 may be immersed in a liquid contained in the outlet-side liquid reservoir. The inlet-side liquid reservoir may include a plurality of inlet electrodes, for example, one inlet electrode for each capillary inlet end 112. The inlet electrodes may be arranged parallel to or coaxial with the capillary inlet ends 112. The outlet-side liquid reservoir may include at least one outlet electrode, which often is connected to electrical ground relative to the inlet electrodes. The inlet electrodes and outlet electrode(s) are in electrical communication with a high-voltage (HV) circuit. In a CE application, a buffer solution is contained in the inlet-side liquid reservoir, the outlet-side liquid reservoir, and the inner bores of the capillaries 104. The buffer solution is formulated to provide ions for electrolytic activity. Accordingly, an electrical circuit is completed between the contents of the capillaries 104 and the HV circuit. In operation, the HV circuit applies a voltage (e.g., 15 kV), or sequence of voltage pulses of predetermined parameters (pulse width, pulse shape, etc.) across the lengths of the capillaries 104 to cause electrophoretic separation of different analytes of the samples residing in the capillaries 104. Prior to the electrophoretic separation, the HV circuit may also be utilized to inject samples into capillaries 104, such as by applying a suitable voltage pulse that draws samples from respective sample containers (placed in the position of the inlet-side liquid reservoir) into the corresponding capillary inlet ends 112. Such sample injection may be referred to as electrokinetic or electrophoretic injection. Alternatively, sample injection may be performed hydraulically by creating a pressure differential between sample containers and corresponding capillaries 104.

Each fixture 108 is configured to fix the spacing between the capillaries 104, also referred to herein as the capillary spacing S as illustrated in FIG. 5D. In an implementation, a given fixture 108 is configured to fix the capillaries 104 in parallel. In other implementations, however, a given fixture 108 may be configured to fix the capillaries 104 in a non-parallel spatial relation. For example, a fixture 108 may be configured to fix the capillaries 104 so that they converge towards each other (or equivalently, depending on the sense of direction, diverge away from each other). In another example, a fixture 108 may be configured to fix the capillaries 104 so that they run through one or more bends or turns within the fixture 108.

As shown in FIG. 1, the capillary spacing may be different in different fixtures 108 (e.g., fixtures 108A, 108B, and/or 108C). In such case, different fixtures 108A, 108B, and 108C may have different sizes (dimensions). Outside the fixtures 108A, 108B, and 108C, however, the spacing between the freely suspended (or non-fixed) capillaries 104 may vary along the length of the capillary array assembly 100. For example, the capillary spacing (and overall positional relation in 2D or 3D space) may be non-uniform at and in the vicinity of one or more of the bends 120A, 120B, 120C, and 120D. As another example, the capillaries 104 may converge towards each other (or, depending on the sense of direction, diverge away from cach other) at one or more sections of the capillary array assembly 100, for example at converging (or diverging) sections 124A and 124B shown in FIG. 1. One or more fixtures 108A, 108B, and/or 108C may be utilized to set or recover a linear array of the capillaries 104 with a uniform capillary spacing, such as following a section of non-uniform positional spacing (e.g., bends 120A, 120B, 120C, and 120D, converging sections 124A and 124B, etc.).

In addition to securely holding the capillaries 104 in a fixed spatial relation, a given fixture 108 may be configured to provide one or more other functions. For example, the capillary array assembly 100 may be mounted to a capillary support frame (not shown) that holds the capillary array assembly 100 in a desired 2D or 3D arrangement. Such capillary support frame may facilitate transporting or carrying the capillary array assembly 100 to and from a CE instrument. Alternatively or additionally, the capillary support frame may be mounted along with the capillary array assembly 100 in the interior chamber of the CE instrument to support the capillary array assembly 100 during operation. A given fixture 108 may include one or more mounting features (e.g., bosses, protrusions, pins, recesses, holes, fastening components, locking components, threads, etc.) configured to engage corresponding mounting features of the capillary support frame. Alternatively or additionally, a given fixture 108 may include one or more mounting features configured to engage corresponding mounting features (e.g., provided with a wall or other structure) of the interior chamber of the CE instrument.

In use, the inlet ends 112 of the capillaries 104 may be immersed in liquid contained in an inlet-side liquid reservoir as noted above. Depending on the application or stage of an application, the liquid may be, for example, a buffer solution for providing ions for electrolytic activity, a solution for providing compounds for forming an inner coating (or lining) on the inside surfaces of the capillaries 104 that define their inner bores (or lumens), a solution for providing an electrophoretic separation medium in the inner bores (e.g., a gel), or a sample solution containing the samples that are to be loaded in the capillaries 104 and electrophoretically separated into different analytes for detection/measurement. In an implementation, a fixture 108 located at or near the inlet end (e.g., fixture 108A) may be configured to position the capillaries 104 relative to the inlet-side liquid reservoir so that the inlet ends 112 may be immersed in the liquid. In the case where the inlet-side liquid reservoir is the sample source, the inlet-side liquid reservoir may include a plurality of sample containers to facilitate loading the samples residing in each sample container separately into corresponding capillaries 104. In this case, the fixture 108A may be configured to position the capillaries 104 so that their inlet ends 112 are respectively aligned with the corresponding sample containers.

The outlet ends 116 of the capillaries 104 may be immersed in liquid contained in an outlet-side liquid reservoir as noted above. Depending on the application or stage of an application, the liquid may be one of the solutions noted above in regard to the inlet-side liquid reservoir, except for the sample solution (in other words, the sample source is associated with the inlet-side liquid reservoir in the implementation illustrated in FIG. 1). The outlet-side liquid reservoir may also serve as a collection receptacle that receives liquid flowing out from the outlet ends 116. In some implementations, in the sections of the capillaries 104 closest to and terminating at the outlet ends 116, the capillaries 104 may be collected and bundled tightly together, particularly if on-capillary detection is being implemented upstream of the outlet ends 116. For this purpose, the capillary array assembly 100 may include a capillary outlet header 128 located at or near the outlet ends 116. As illustrated, the outlet header 128 may be cylindrical with a circular bore. Alternatively, the cross-section of the bore of the outlet header 128 may be square-shaped, rectilinear-shaped, oval-shaped, racetrack-shaped, etc.

In an implementation, a fixture 108 as described herein may be utilized in the place of the capillary outlet header 128 shown in FIG. 1. As one example, such implementation may be desired in a case where, as an alternative to on-capillary detection, the outlet-side liquid reservoir is configured as a flow cell for detection/measurement of analytes that have been electrophoretically separated in the capillaries 104. For example, an optical detection system of a CE instrument may be positioned such that an excitation light beam interacts with (e.g., parallel) sample streams emitted from the outlet ends 116 of the capillaries 104 that extend into the outlet-side liquid reservoir.

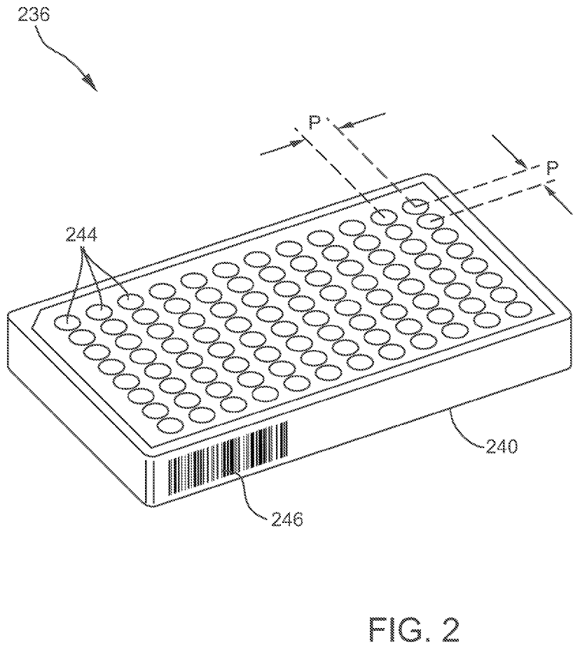

In some implementations, the above-noted inlet-side liquid reservoir may have a 2D array of sample containers. As one example, FIG. 2 is a perspective view of an inlet-side liquid reservoir in the form of a multi-well plate 236. The multi-well plate 236 includes a support structure 240 and a two-dimensional (2D) array (i.e., defined by rows and columns) of wells 244, which are often integrally formed with the support structure 240. The multi-well plate 236 may also include a barcode 246 to facilitate identification and tracking of the multi-well plate 236. The 2D array of wells 244 may be a 2:3 rectangular array, such as the 96-well array (8 rows and 12 columns) shown in FIG. 2. The 2D array may have a greater number of wells (e.g., 384, 1536, etc.) or a lesser number of wells (e.g., 24, 54, etc.) than shown in FIG. 2. As another alternative, the 2D array may be a square array, such as a 4×4 array of 16 wells or an 8×8 array of 64 wells. In an implementation, the multi-well plate 236 has a uniform pitch P between adjacent wells 244 in each row and in each column of the array. As an example, the pitch P may be taken to be the distance between the centers of two adjacent wells 244 (i.e., the center-to-center distance). In an implementation, the format of the multi-well plate 236, including the dimensions and the shape of the wells 244, is a standard format in accordance with known standards such as the American National Standards Institute/Society for Laboratory Automation and Screening (ANSI/SLAS) standards for multi-well plates current at the time of filing the present disclosure. For example, the pitch P may be as specified by ANSI/SLAS 4-2004 (R2012): Microplates-Well Positions. Thus, the pitch P may be 9.0 mm for an array of 96 wells 244, 4.5 mm for an array of 384 wells 244, or 2.25 mm for an array of 1536 wells 244.

In an implementation that utilizes a 2D array of sample containers (e.g., wells 244) such as shown in FIG. 2, the inlet ends 112 of the capillaries 104 shown in FIG. 1 may be arranged in a 2D array that matches the 2D array of sample containers in terms of the row-to-column ratio. In addition, the spacing or pitch between the capillaries 104 (along each row and between adjacent row) may match that of the sample containers, such as the pitch P between the wells 244 shown in FIG. 2. In addition, the total number of capillaries 104 may match the total number of sample containers such that each capillary 104 is associated with a corresponding sample container, which enables samples from all sample containers to be injected into the corresponding capillaries 104 simultaneously if desired. In this implementation, in FIG. 1, the linear array of four capillaries 104 shown closest to and terminating at the inlet ends 112 may depict just one row of a 2D array defined by two or more rows of capillaries 104, with the additional rows of capillaries 104 not being visible in FIG. 1. The 2D arrangement of capillaries 104 and sample containers (e.g., wells 244) facilitates the insertion of each capillary 104 (along with a corresponding inlet electrode as noted above) into a corresponding sample container. In an implementation, a plurality of fixtures 108A may be provided to support a plurality of rows of capillaries 104, respectively, at or near the inlet ends 112. Such fixtures 108A may be positioned in parallel and spaced from each other in an appropriate manner. For example, the fixtures 108A may be engaged with a suitable support structure (not shown) configured to set the positions of the fixtures 108A (and thus the rows of capillaries 104 respectively held by the fixtures 108A) relative to each other.

In an implementation, another fixture 108 (e.g., fixture 108B) may be configured to convert (or transition) the 2D array of capillaries 104 located at the inlet end into a single linear array that contains all of the capillaries 104 in a side-by-side arrangement. For this purpose, the size (e.g., width) of the fixture 108B may be appreciably larger than the size schematically depicted in FIG. 1 (relative to other objects illustrated in FIG. 1). Alternatively, the conversion or transition from the 2D array to the single 1D array of capillaries 104 may be achieved in two or more stages. For example, two or more fixtures (not shown) may be intermediately positioned between the fixtures 108A and the fixture 108B. Each of the intermediate fixtures may convert a subset of the 2D array of capillaries 104 into a respective linear array, resulting in two or more linear arrays, which are then combined by the fixture 108B into a single linear array containing all of the capillaries 104.

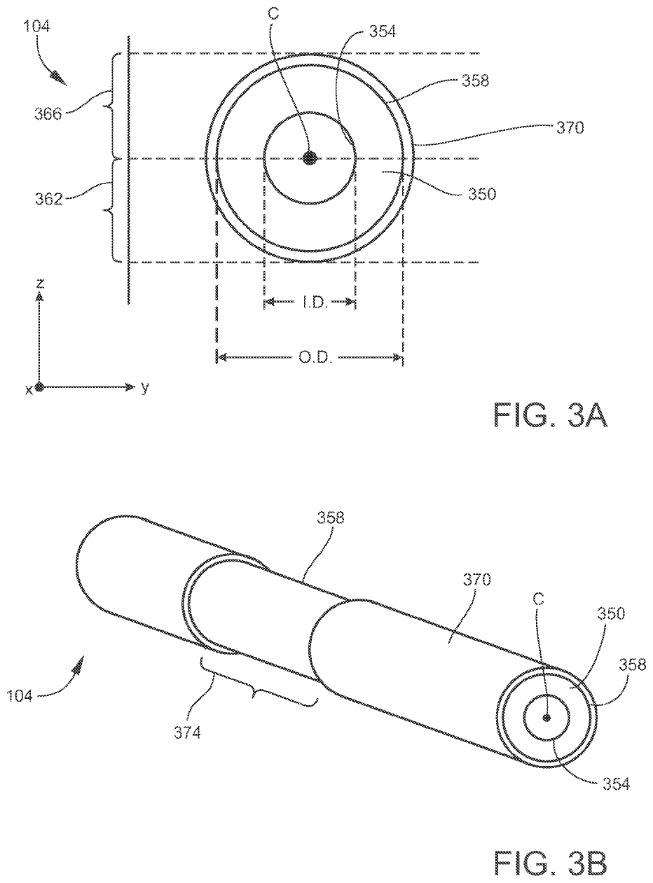

In an implementation, another fixture (e.g., fixture 108C) may be configured as, or as part of, an on-capillary detection cell. This type of detection cell is defined by optically transparent sections of the capillaries 104, or capillary windows, as noted above in the Background section. An example of a capillary window 374 is illustrated in FIG. 3B and described below. In this case, the capillary array assembly 100 is mounted in a CE instrument in a manner that positions the capillary windows 374 in optical alignment with the optical detection system of the CE instrument. Generally, the optical detection system includes a light source configured to emit excitation light and a light detector configured to receive emission light. In the present context, “optical alignment” means that the capillary windows 374 are positioned relative to the optical detection system such that the excitation light can be successfully incident on the capillary windows 374 (e.g., on all capillary windows simultaneously), and the emission light emitted from the capillary windows 374 can be successfully collected or captured by the light detector, thereby enabling the generation of data (e.g., electropherograms) pertaining to the electrophoretically separated analytes under analysis. In this implementation, the sections of the capillaries 104 containing the capillary windows 374 are held by the fixture 108C.

FIG. 3A is a cross-sectional view (or, alternatively, an end view) of an example of one of the capillaries 104. FIG. 3B is a perspective view of the capillary 104 illustrated in FIG. 3A, or at least a portion of the length of the capillary 104. For purposes of reference and description, FIG. 3A and certain other drawing figures include an arbitrarily positioned Cartesian coordinate (x-y-z) frame. The x-axis, y-axis, and z-axis also may be referred to herein as the longitudinal axis, transverse axis, and elevational axis, respectively. The terms “x-direction”, “y-direction”, and “z-direction” may also be used to refer to the x-axis, y-axis, and z-axis, respectively. Dimensions along the x-axis, y-axis, and z-axis are taken to be length, width, and height (or thickness), respectively. The capillary 104 has a central axis, or capillary axis C, along which the capillary 104 is elongated. In a straight section of the capillary 104, the capillary axis C is taken to be coincident or parallel with the x-axis. The y-z plane is referred to herein as the transverse plane. The cross-sectional view of FIG. 3 is taken in the transverse plane.

The capillary 104 has a hollow cylindrical (tube-shaped) capillary body 350. Typically, the cross-section of the capillary body 350 is circular and annular, as illustrated. The capillary body 350 has a radial thickness between a capillary inside surface 354 and a capillary outside surface 358. The capillary inside surface 354 defines (coaxially surrounds, as a boundary of) the inner bore (or lumen) of the capillary 104 (also referred to herein as the capillary bore) and thus also defines the inside diameter (I.D.) of the capillary 104 (capillary I.D.). If the capillary 104 is bare (e.g., uncoated), or at a bare section of the capillary 104, the capillary outside surface 358 defines the outside diameter (O.D.) of the capillary 104 (capillary O.D.). As one example, the capillary I.D. may be in a range from 0.5 μm to 200 μm, and the capillary O.D. may be in a range from 50 μm to 400 μm. The capillary 104 (or capillary body 350) may be considered as having a lower (or bottom, or first) capillary half (or half portion) 362 and an upper (or top, or second) capillary half (or half portion) 366, the shapes of which are semi-cylindrical with semi-circular cross-sections. As described below, when the capillary 104 is assembled to a fixture 108, the lower half portion 362 may be fully embedded and the upper half portion 366 may be at least partially embedded by substrate material of the fixture 108. In the present context, the terms “lower” and “upper” are relative terms used to distinguish the lower half portion 362 and the upper half portion 366 from each other.

The capillary body 350 is composed of an optically transparent material. In the present context, a “transparent” material is a material that allows transmission of light propagating at wavelengths in a range that includes (at least) the wavelength or wavelengths of excitation light and emission light employed in the use of the capillary array assembly 100. Depending on the embodiment, the excitation light and/or emission light may be ultraviolet light, visible light, or infrared light. Examples of the material of the capillary body 350 include, but are not limited to, silica, fused silica, fused quartz, doped (synthetic) fused silica, and polymers like polytetrafluorocthylenc (PTFE).

In an implementation, the capillary 104 may include an outer protective layer (or coating, film, etc.) 370 in contact with and coaxially surrounding the capillary outer surface 358. The protective layer 370 is configured to protect the capillary 104 from damage or breakage, and to add strength or robustness to the capillary 104 to allow the capillary 104 to be bent to a certain degree (see, e.g., FIG. 1) without being damaged or broken. The protective layer 370 also substantially blocks the transmission of light at least in the expected wavelength ranges of excitation light, emission light, and stray light. The protective layer 370 may be composed of various materials suitable for this purpose, such as various polymers, examples of which include, but are not limited to, polyimide (PI), acrylate, silicone, and fluoropolymers. As one example, the protective layer 370 may have a radial thickness in the transverse plane in a range from 5 μm to 30 μm. When the protective layer 370 is included, the O.D. specified for the capillary 104 may include (account for) the radial thickness of the protective layer 370.

FIG. 3B illustrates an implementation in which the capillary 104 includes a capillary window 374. The capillary window 374 may be formed by any suitable technique now known or later developed. As an example, the capillary 104 may be fabricated by first forming the capillary body 350, then coating the entire length of the capillary body 350 to form the protective layer 370, and then stripping the protective layer 370 from a selected longitudinal section of the capillary 104 to form the capillary window 374. As another example, a mask may be applied to the longitudinal section of the capillary 104 where the capillary window 374 is to be formed, the capillary body 350 may then be coated with the material of the protective layer 370, and the mask may then be removed. In a capillary array, all of the respective capillary windows 374 may be located together to collectively form the optical window of a detection cell, as described above in conjunction with FIG. 1.

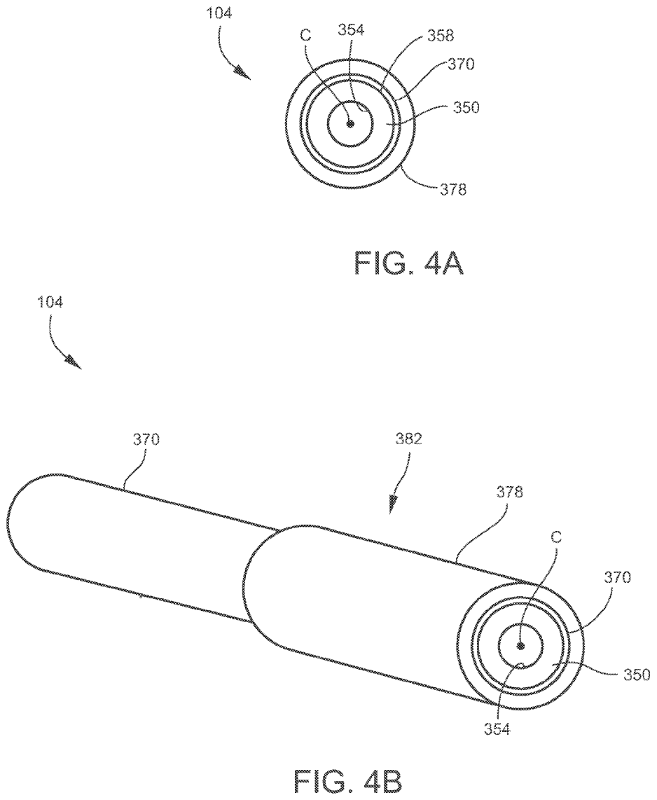

FIG. 4A is a cross-sectional (or, alternatively, an end view) of another example of one of the capillaries 104. FIG. 4B is a perspective view of the capillary 104 illustrated in FIG. 4A, or at least a portion of the length of the capillary 104. In this example, the capillary 104 includes one or more additional outer layers 378 that surround at least one longitudinal section of the capillary 104. The additional outer layer(s) 378 may be configured to perform various functions depending on the application. As one example, the additional outer layer 378 (or at least one of multiple additional outer layers 378 provided) may be composed of an electrically conductive material, i.e., the additional outer layer(s) 378 may constitute an electrode. For example, the additional outer layer(s) 378 may serve as a coaxial inlet electrode located at or near the inlet end 112 (FIG. 1) of the capillary 104, as described above in conjunction with FIG. 1. In this case, the electrically conductive portion of the additional outer layer(s) 378 may be placed in electrical communication with the high-voltage (HV) circuit of a CE instrument by any appropriate technique.

In another example, the additional outer layer 378 (or at least one of multiple additional outer layers 378 provided) may be composed of a thermally conductive material. The thermally conductive material may be utilized as a solid heat transfer medium for either cooling or heating the capillary 104 or a selected longitudinal section of the capillary 104. For example, the thermally conductive material may function as a heat sink, and/or placed in thermal contact with a cooling device (e.g., a Peltier device) for removing Joule heat energy generated by application of the HV field utilized for electrophoretic separation. As another example, the thermally conductive material may be utilized as part of a heating system configured to heat the capillary 104.

In all such cases, the additional outer layer(s) 378 may be supported by a fixture 108 along with the corresponding capillary 104. The longitudinal section of the capillary 104 containing the additional outer layer(s) 378 (e.g., section 382 illustrated in FIG. 4B) may be entirely positioned within the fixture 108 or partially extend outside the fixture 108.

Any suitable materials may be utilized for additional outer layer(s) 378 that are electrically and/or thermally conductive. Examples include, but are not limited to, various metals, metal alloys, electrically and/or thermally conductive polymers, etc.

FIG. 4B illustrates a section 382 of the additional outer layer(s) 378. In the illustrated example, the section 382 extends over only a portion of the length of the capillary 104. Depending on the application (e.g., the function of the additional outer layer(s) 378), capillary 104 may include two or more sections 382, which may be spaced from each other along the length of the capillary 104. In another example, the additional outer layer(s) 378 may extend over the entire length of the capillary 104.

In various implementations, the capillary 104 may include a combination of two or more features shown FIGS. 3A-4B. For example, the capillary 104 may include the protective layer 370, capillary window 374, and/or one or more sections 382 of the additional outer layer(s) 378.

In the implementations illustrated in FIGS. 3A-4B, the capillary 104 may be considered as having an outermost capillary surface that is in direct contact (directly interfaced) with the fixture 108. Depending on the implementation, the outermost capillary surface may correspond to the capillary outside surface 358 (e.g., in a bare section of the capillary 104), the outside surface of the protective layer 370, or the outermost surface of the additional outer layer(s) 378 (e.g., the outside surface of an electrically or thermally conductive layer, or of a protective layer that coaxially surrounds an electrically or thermally conductive layer).

FIGS. 5A-5D illustrate an implementation of the capillary array assembly 100. FIG. 5A is a perspective view of the capillary array assembly 100 (or a portion thereof). FIG. 5B is a top plan view of the capillary array assembly 100 in the x-y plane. FIG. 5C is a cross-sectional (or, alternatively, an end view) of the capillary array assembly 100 in the y-z (transverse) plane. FIG. 5D is an enlarged cross-sectional (or, alternatively, an end view) of a portion of the capillary array assembly 100 shown in FIG. 5C, also in the y-z (transverse) plane.

The fixture 108 includes a structured substrate 502, i.e., a substrate 502 that has been structured (or engineered) to include structural features. In the present implementation, the fixture 108 may be primarily or even solely defined by the body of material constituting the substrate 502, or substrate body 546. Accordingly, in this implementation, the terms “fixture” and “substrate” may refer to essentially the same structural component. In other implementations, however, the fixture 108 may include additional features considered to be separate or distinct from the features that are integrally part of the substrate 502 (substrate body 546) illustrated in FIGS. 5A-5D.

Generally, the substrate 502 (substrate body 546) may be composed of any rigid (stiff) material effective for reliably fixing the capillaries 104 in the manner described herein. Accordingly, the substrate material may be selected from various metals (e.g., aluminum, etc.), metal alloys (e.g., stainless steel, etc.), metalloids (e.g., silicon), ceramics (e.g., glasses), and polymers. In one implementation, the substrate material may be a thermoplastic (e.g., an “engineering thermoplastic”). Examples of suitable thermoplastics include, but are not limited to, acrylics, acrylonitrile butadiene styrene (ABS), nylon, polycarbonate (PC), polyether sulfone (PES), polyoxymethylene (POM), polyether ether ketone (PEEK), polyetherimide (PEI), polyethylene (PE), polyphenylene oxide (PPO), polyphenylene sulfide (PPS), polypropylene (PP), polyvinyl chloride (PVC), polyvinylidene fluoride (PVDF), polytetrafluoroethylene (PTFE), etc.

In one implementation, the substrate body 546 is a single-picce (or monolithic) body of material. In other words, in such implementation, the substrate body 546 does not include (or is not defined by) multiple layers of material attached to each other. For example, the substrate body 546 may be a non-laminated body, i.e., does not include two or more layers of material laminated together.

The substrate 502 has a substrate length in the x-direction, a substrate width in the y-direction, and a substrate height in the z-direction. Any one dimension (length, width, and height) of the substrate 502 may be greater than, less than, or equal to one or both of the other two dimensions, as needed for a particular implementation. In the present implementation, the dimensions of the substrate 502 may essentially correspond to the overall dimensions of the fixture 108 as a whole. The capillaries 104 are elongated along the substrate length and spaced from each other along the substrate width. Typically, but not necessarily, the capillaries 104 are positioned at the same height (or elevation level) relative to the substrate height. As noted above, the capillaries 104 may be parallel to each other along the entire substrate length or, alternatively, may be non-parallel along some or all of the substrate length.

In the present implementation, the substrate 502 has a 3D, rectilinear outer shape, which also may be referred to as a prismatic shape, box shape, plate shape, etc. Hence, the substrate 502 has six outside surfaces: a top outside surface 506, a bottom outside surface 510 spaced from the top outside surface 506 in the z-direction, and four lateral outside surfaces 514 adjoining the top outside surface 506 and the bottom outside surface 510. The top outside surface 506, bottom outside surface 510, and lateral outside surfaces 514 may be entirely flat as illustrated. Alternatively, one of more of these outside surfaces may have one or more geometrical features such as bends or curves, additional corners or edges, etc., depending on the implementation. More generally, the substrate 502 has an outer shape effective for fixing the capillaries 104, or additionally to provide additional functions, in the manner described herein.

As examples of structural features, the substrate 502 includes a plurality of capillary channels 518 and a plurality of slots 522. The capillary channels 518 and the slots 522 extend along the length of the substrate 502. Each capillary 104 is located in a corresponding one of the capillary channels 518. Each slot 552 is located above a corresponding one of the capillary channels 518, and extends from the top outside surface 506 down to the capillary channel 518 and the capillary outside surface 358 of the corresponding capillary 104. By this configuration, the spatial relation (e.g., relative positions and orientations) of the capillaries 104 are determined by the capillary channels 518 and the spacing between the capillary channels 518. In addition, in the present implementation, the capillaries 104 are embedded (or enclosed) by the capillary channels 518 except where the slots 552 are located. That is, at the slots 552, the capillaries 104 are exposed to the surroundings outside the substrate 502.

Referring to the close-up view of FIG. 5D, the substrate 502 sets a capillary spacing S between each pair of adjacent capillaries 104. Typically, the capillary spacing S is defined at the height (or elevation level) of the capillary axes C. Further, as illustrated, the capillary spacing S may be defined as the distance between the capillary axes C of two adjacent capillaries 104, i.e, the center-to-center distance. As one example, the capillary spacing S may be the value of the capillary O.D. plus 30 μm, or the value of the capillary O.D. plus 30 μm or greater (e.g., capillary O.D. plus 35 μm, capillary O.D. plus 40 μm, capillary O.D. plus 50 μm, etc.). In other examples, the capillary spacing S may be in a range from 100 μm to 600 μm. In further examples, the capillary spacing S may be 200 μm, 250 μm, 300 μm, 350 μm, 400 μm, 450 μm, 500 μm, 550 μm, or 600 μm. Alternatively, the capillary spacing S may be defined as the closest distance between two adjacent capillaries 104, which occurs at the height of the capillary axes C. Generally, the capillary spacing S may be set to be appropriate for fixtures 108 located at various points along the length of the capillary array assembly 100, and thus may depend on the function/use of a specific fixture 108 at a certain location. All or part of the ranges specified herein may be appropriate when the fixture 108 is utilized as, or as part of, an on-capillary detection cell. For a detection cell, the acceptable range of the capillary spacing may depend on factors such as cross-talk between capillaries 104 and other unwanted optical effects. However, the capillary spacing S may be greater or less than the ranges just specified, depending on the functions/uses of the fixture 108. For example, the capillary spacing S may be greater when the fixture 108 is utilized at or near an inlet-side liquid reservoir. In this case, the capillary spacing S may be set to match the pitch P of sample containers of a sample source as described above in conjunction with FIG. 2. As another example, the capillary spacing S may be less when the fixture 108 is utilized at or near an outlet-side liquid reservoir, for example, if it is desired to bundle the capillaries 104 closely together at the outlet end of the capillary array assembly 100. As a more general example, the capillary spacing S may be in a range from 10 μm to 9000 μm. The fabrication method disclosed herein is flexible enough to allow for any of the ranges just specified.

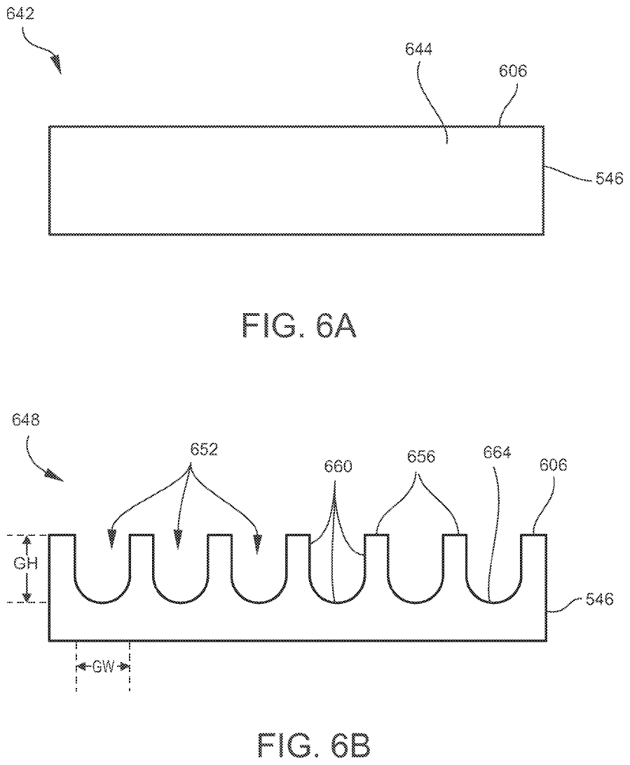

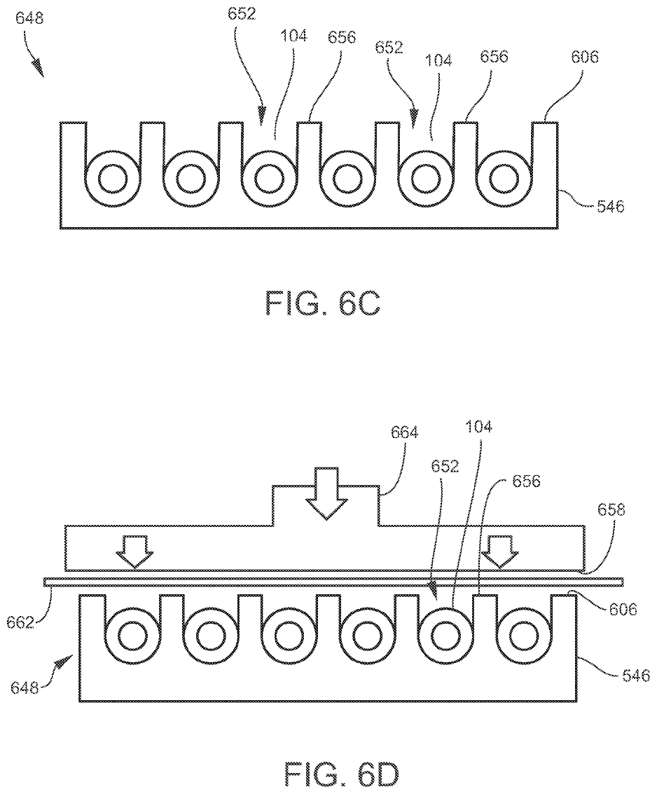

As further shown in FIG. 5D, for purposes of description, the substrate 502 may be considered as including a substrate base (portion or region) 526 and a capillary spacer (or spacer/embedding portion or region) 530. The substrate base 526 is that portion or region of the substrate 502 that underlies (from the perspective of the transverse plane), and is not occupied by, the capillaries 104. The substrate base 526 may span the entire substrate width and thus may include the entire bottom outside surface 510. The substrate base 526 extends upwards from the bottom outside surface 510 towards the capillary channels 518. The size (dimensions) of the substrate base 526 may vary depending on the specific implementation of the fixture 108. For example, the substrate base 526 may be sized to accommodate the provision of mounting features or other additional features described above. As another example, the substrate base 526 may be sized to serve as a heat sink that effectively absorbs heat energy generated in the capillaries 104 during use (e.g., Joule heating), or as a solid heat transfer medium that effectively conducts heat energy away from the capillaries 104 to an external structure or cooling device (not shown). The substrate base 526 may be sized to serve as a heat sink during a heat-based capillary fixing process such as described below in conjunction with FIGS. 6A-6D.

The capillary spacer 530 is that portion or region of the substrate 502 that is above the substrate base 526 and is occupied by the capillaries 104. Moreover, the capillary spacer 530 defines the capillary spacing S, and directly contacts and embeds the capillaries 104. Thus, the capillary spacer 530 (or at least a substantial part thereof) is interdigitated with the capillaries 104. Accordingly, the capillary spacer 530 (or at least a substantial part thereof) may be considered as including a plurality of distinct capillary spacers 530 (or distinct portions of regions of the capillary spacer 530), with each individual capillary spacer 530 being adjacent to one or two of the capillaries 104. Further, the capillary spacer 530 (or each capillary spacer 530) may be considered as including a lower (or first) capillary spacer half (or half portion or region) 534 and an upper (or second) capillary spacer half (or half portion or region) 538. The lower capillary spacer half 534 underlies and fully embeds the capillaries 104 (in particular, the lower capillary halves 362, FIG. 3A). The upper capillary spacer half 538 at least partially overlies and thus at least partially embeds the capillaries 104 (in particular, the upper capillary halves 366, FIG. 3A). Thus, as shown in FIG. 5D, each slot 522 is defined between longitudinal edges of adjacent parts of the upper capillary spacer half 538 (or adjacent upper capillary spacer halves 538). By this configuration, the capillary spacer 530 provides an interference fit between each capillary 104 and the substrate 502 in one or more directions. The interference fit is due in particular to the direct (and tight) contact between the capillary spacer 530 and the capillary outer surface 358, and the portions of the capillary spacer 530 (i.e., upper capillary spacer half/halves 538) that overlie the capillary outer surface 358. The interference fit prevents the capillaries 104 from being removed from the substrate 502, such as by pulling the capillaries 104 in the longitudinal (x) direction or in the upward (z) direction.

In FIG. 5D, dashed lines schematically distinguish the different portions or regions just described for purposes of reference and description. The dashed lines do not necessarily depict physical boundaries or interfaces between the different portions or regions. For example, when the substrate body 546 is a single-piece body, the dashed lines may generally designate locations where the different portions or regions transition into each other.

Generally, the slots 522 each have a slot width in the transverse direction (along the substrate width) that is less than the capillary O.D. Generally, the size of the slot width may be selected to provide an effective interference fit with the capillaries 104 in the direction of the substrate height. When the fixture 108 is utilized at a detection cell, the size of the slot width may also be selected to accommodate (i.e., ensure adequate exposure of) capillary windows 358 (FIG. 3B). In one example, the slot width is greater than the capillary I.D. but less than the capillary O.D. In another example, the slot width is greater than the capillary I.D. but is closer to the capillary I.D. than to the O.D. In another example, the slot width is equal to or (as illustrated in FIG. 5D) less than the capillary I.D. In another example, the slot width is in a range from 0 μm to 300 μm.

The extent to which the capillary spacer 530 embeds each capillary 104 also may be described relative to the percentage of the capillary outer surface 358 that is covered by the capillary spacer 530. As noted above, the lower capillary spacer half 534 fully embeds each lower capillary half 362 (FIG. 3A) and thus covers (encloses) 100% of the outside surface (or outside surface area) of the lower capillary half 362. The upper capillary spacer half 538 may partially embed each upper capillary half 366 (FIG. 3A) and thus may cover (enclose) a percentage (fraction) of the entire outside surface (or outside surface area) of the upper capillary half 366. In an example, the percentage of the outside surface of the upper capillary half 366 covered by the capillary spacer 530 (particularly, by the upper capillary spacer half 538) may be in a range from 0% to 80%.

The capillaries 104 shown in FIGS. 5A-5D may include the protective layer 370 (or additionally the capillary window 374) shown in FIGS. 3A and 3B, and/or one or more sections 382 of the additional outer layer(s) 378 shown in FIGS. 4A and 4B. Depending on the fixture 108, such features may be entirely or partially fixed by the substrate 502. Hence, the capillary channels 518 may be sized and shaped to accommodate such features as needed. Alternatively, such features may be located entirely outside the substrate 502.

In another implementation, the capillary spacer 530 may fully embed the upper capillary half 366 (FIG. 3A) of one or more of the capillaries 104 along all or part of the substrate length. At such locations, the overlying slot 522 is not present

A method for fabricating a capillary array assembly 100 such as illustrated in FIGS. 5A-5D will now be described with additional reference being made to FIGS. 6A-6D, which illustrate certain steps or the results of steps of the fabrication method.

Referring to FIG. 6A, a blank substrate (or workpiece) 642 is provided. The blank substrate 642 is “blank” in the sense that it has not yet been processed to form any features. However, the blank substrate 642 may have first been reduced to a desired size before forming features or performing further steps of the fabrication method. For example, the blank substrate 642 in FIG. 6A may represent the substrate body 546 after it has been formed (e.g., cut, extruded, etc.) from a larger piece or volume of substrate material. In this example of the fabrication method, the substrate body 546 is a single-piece material. Also in this example, the single-piece substrate body 546 is composed of a thermoplastic material such as one of the examples specified above. The blank substrate 642 (substrate body 546) includes a top outside surface 606 and other outside surfaces that may be pre-processed forms of (or correspond to) the top outside surface 506 and other outside surfaces of the final (post-processed) substrate 502 shown in FIGS. 5A-5D.

Referring to FIG. 6B, after providing the blank substrate 642, the blank substrate 642 is then processed to form desired features on or in the blank substrate 642, resulting in an intermediate structured substrate 648. The intermediate structured substrate 648 is “intermediate” in the sense that it will undergo further processing in one or more subsequent steps of the fabrication method. Generally, any processing technique appropriate for the selected thermoplastic material may be performed, such as injection molding, compression molding, calendering, extrusion, casting, stamping, embossing, mechanical machining, lathing, milling, drilling, lascr machining, rapid prototyping, additive manufacturing, 3D printing, subtractive manufacturing, etc. Depending on the processing technique, the bulk substrate material represented by blank substrate 642 in FIG. 6A may need to be provided in a granulated or pelletized form in preparation for a certain processing step, and at some point may exist as a heated, flowable, viscous phase, as appreciated by persons skilled in the art.

In the present example, features formed by the fabrication method include a plurality of grooves 652. The size, number, and spatial arrangement (e.g., linear array) of the grooves 652 are selected to accommodate the capillaries 104 that are to be fixed to the substrate body 546. In the present example, the grooves 652 are formed such that the grooves 652 extend from the top outside surface 606 into the substrate thickness, and the grooves 652 are separated from each other by intervening regions of the substrate body 546 referred to herein as groove dividers (or walls, or bars) 656. Each groove 652 has a groove inside surface 660 defined by the outside surfaces of adjacent groove dividers 656 and the underlying portion of the substrate body 546. The bottom portion of each groove 652 includes a lowermost point 664 of the groove 652 (and of the groove inside surface 660). The bottom portion of each groove 652 may be semi-circular to conform to the circular cross-section of the capillary 104 to be added, as illustrated in FIG. 6B. Each groove 652 has an initial groove height GH defined by the distance between and up to the lowermost point 664 and the top outside surface 606. Each groove 652 has an initial groove width GW defined by the distance between adjacent groove dividers 656. The initial groove height GH and groove width GW are “initial” in the sense that these dimensions may change as a result of further processing.

Alternatively, the bottom portions of the grooves 652 may have other types of rounded shapes (e.g., oval) that do not necessarily conform to the circular profile of the capillaries 104. Moreover, the bottom portions of the grooves 652 may have polygonal shapes (e.g., rectilinear, square, angled, trapezoidal, V-shaped, etc.).

Besides the grooves 652, additional features (not shown) such as described herein (e.g., mounting features, etc.) may be formed on or in the blank substrate 642 and thus may be part of the intermediate structured substrate 648. Some features, such as the grooves 652, are intermediate features in the sense that such features are further processed in one or more subsequent steps of the method. Other features may be final features in the sense that they are not (substantially) processcd further after the stage of the fabrication method shown in FIG. 6B. For example, mounting features formed at this stage may not need to be further processed.

Referring to FIG. 6C, after forming the grooves 652, capillaries 104 are inserted into the respective grooves 652. If needed, a suitable tool (not shown) may be utilized to assist in inserting the capillaries 104. The capillaries 104 may be inserted such that the capillaries 104 are brought into contact with at least part of the bottom portions of the grooves 652 along the entire length of the intermediate structured substrate 648. This may ensure that the capillaries 104 are accurately aligned with each other and may facilitate a uniform and repeatable fixing process. Depending on the shape of the bottom portions, the capillaries 104 may be inserted so as to make full contact with the bottom portions, which may include contact with the lowermost points 664. The initial groove width GW (FIG. 6B) may be slightly (e.g., up to 20%) greater than the capillary O.D. to accommodate the insertion and alignment of the capillaries 104. The initial groove width GW may “shrink to fit” the capillary O.D. as a result of the subsequent fixing process. As one example, the initial groove width GW may be about 200 μm to accommodate capillaries 104 of 193 μm O.D.

As noted above, the bottom portions of the grooves 652 may have rounded or polygonal shapes that do not conform to the circular profile of the capillaries 104. In such case, in some implementations of the subsequent fixing process, portions of the groove dividers 656 and/or underlying substrate body 546 may at least partially shrink to fit to the outside surface of the lower capillary halves 362.

In the present implementation, the groove dividers 656 are utilized in a subsequent method step as a source of substrate material for at least partially embedding the upper half portions 366 (FIG. 3A) of the capillaries 104. To provide a sufficient amount of substrate material for this purpose, the initial height of the groove dividers 656, which may (substantially) correspond to the initial groove height GH (FIG. 6B), may be greater than the O.D. of the capillaries 104, as illustrated in FIG. 6C. As one example, the initial height of the groove dividers 656 (or initial groove height GH) may be in a range of 125% to 200% of the O.D. of the capillaries 104. In another example, the initial height of the groove dividers 656 (or initial groove height GH) may be greater than 200% of the O.D. of the capillaries 104. The initial width of the groove dividers 656 may be considered when determining the capillary spacing S of the final (post-processed) substrate 502 shown in FIG. 5D, as the width (like the height) of the groove dividers 656 may change as the result of one or more subsequent method steps. The initial width of the groove dividers 656 may also be considered when determining the initial height of the groove dividers 656, or more generally when determining the total amount of substrate material needed for at least partially embedding the upper half portions 366 of the capillaries 104.

Referring to FIG. 6D, after inserting the capillaries 104, the intermediate structured substrate 648 is processed in a manner that fixes capillaries 104 to (and in) the substrate body 646. The intermediate structured substrate 648 may be securely positioned on a work surface. Depending on the implementation, the intermediate structured substrate 648 may be placed in a structure that has one or more walls adjacent to one or more sides of the intermediate structured substrate 648. In the present implementation, the capillaries 104 are then fixed by applying heat and (downward) force (or pressure) to the top outside surface 606. The process of applying heat and force (or pressure) may be considered as being a type of hot-forming process, for example a heat-staking process. The application of heat and force (or pressure) causes plastic deformation of the thermoplastic material of part of the substrate body 546. The applied heat causes part of the thermoplastic material, particularly in the uppermost regions of the groove dividers 656, to soften (or melt) and consequently become flowable and displaceable. The applied force (or pressure) assists in displacing and directing the flow of the heat-softened thermoplastic material in desired directions. In particular, the applied force (or pressure) assists in causing the heated thermoplastic material to spread outwardly from initial (pre-processed) positions of the groove dividers 656 and over the upper half portions 366 (FIG. 3A) of the capillaries 104. If needed, one or more tools and/or surfaces (not shown) external to the intermediate structured substrate 648 may be utilized to control the extent of the spreading, such as the above-noted structure having one or more walls (e.g., an open-top box-like structure) or as otherwise appreciated by persons skilled in the art. The heat and force (or pressure) are applied for a period of time referred to herein as a fixing time. After the fixing time has elapsed, the heat and force are removed to stop the spreading of the thermoplastic material. After the heat and force are removed, the thermoplastic material cools back down and hardens in place.

Consequently, after completion of the fixing process, the final (post-processed) fixture 108 and associated capillary array assembly 100 shown in FIGS. 5A-5D are formed thereby. For example, the grooves 652, groove dividers 656, and region of substrate body 546 underlying the grooves 652 may be considered as having been transformed into the capillary channels 518, slots 522, capillary spacer(s) 530, and substrate base 526. The fabrication method may further include one or more post-fixing (or finishing) steps as needed. For example, excess substrate material that was displaced/deformed and not needed for the end product may be removed (e.g., trimmed away).

The development of the fabrication method of the present implementation may involve consideration of a combination of parameters that influence the fixing process (fixing parameters), particularly the above-noted amount of applied heat, amount of applied force/pressure, amount of displacement/spreading, and duration of fixing time. Generally, the values of fixing parameters are selected to be effective to form the final fixture 108 and associated (post-processed) capillary array assembly 100 shown in FIGS. 5A-5D. Acceptable ranges may be specified for the rate of heat energy (e.g., in watts, W) transferred to the intermediate structured substrate 648, the amount of force (e.g., in Newtons, N) and/or pressure (e.g., in megapascals, MPa) applied to the intermediate structured substrate 648, and fixing time (e.g., in seconds, sec, or minutes, min) during which the heat and force/pressure are applied. Generally, the rate of heat energy applied, or the total amount of heat (e.g., in Joules, J) applied when also considering the fixing time, should be great enough to soften a sufficient amount of the thermoplastic material to embed the capillaries 104, but not so great as to permanently (or plastically) deform other regions of the substrate body 646 that do not need to be softened (rendered flowable) and deformed/displaced. Similarly, the amount of force/pressure applied should be great enough to spread the heated portions of the thermoplastic material over the capillaries 104, but not so great as to damage the capillaries 104 or damage or deform other regions of the substrate body 646. The duration of the fixing time may be determined based on ranges of the applied heat and force/pressure determined to be optimal for the fixing process. The fixing parameters may also vary for different fixtures 108, e.g., fixtures 108 having different sizes and/or features. For different fixtures 108, the values of the fixing parameters may be determined empirically as needed for optimizing the fabrication process.

As described above, the final capillary array assembly 100 includes at least one fixture 108 but may include several fixtures 108. In the latter case, multiple fixtures 108 may be fabricated according to the presently described method that is illustrated in FIGS. 6A-6D. For a given set of capillaries 104, multiple fixtures 108 may be fabricated simultaneously or sequentially, depending on the specific fabrication method.

The application of heat and force/pressure may be performed by various techniques. In the implementation shown in FIG. 6D, a heated stamp 664 is utilized to apply the heat, force, and displacement of heated material. Generally, heated stamps are known to persons skilled in the art, and thus the illustrated heated stamp 664 is described only briefly herein. The heated stamp 664 may be configured to be manipulated manually or robotically. The heated stamp 664 is composed of a thermally conductive material, which often is a metal or metal alloy but alternatively may be a polymer of suitable thermal stability (i.e., resistance to melting and degradation due to repeated cycling of heating). The heated stamp 664 may be in thermal contact with a suitable heat source, for example, a resistive heating element. Alternatively or additionally, all or part of the heated stamp 664 may also be electrically conductive, such that the heated stamp 664 itself serves as a resistive heating element in response to applied electrical power (current or voltage).

In the present implementation, the heat and force/pressure are applied by pressing the heated stamp 664 onto the top outside surface 606 of the intermediate structured substrate 648 for the designated fixing time, as indicated by arrows in FIG. 6D. The heated stamp 664 includes a contact surface 658, which is the bottom surface of the heated stamp 664 from the perspective of FIG. 6D. Heat energy from the heated stamp 664 is transferred from the contact surface 658 to the top outside surface 606 of the intermediate structured substrate 648. For a given amount of force applied by the heated stamp 664, the size (surface area) of the contact surface 658 determines the amount of pressure applied by the heated stamp 664 to the top outside surface 606. The shape (or geometry) of the contact surface 658 may conform to the shape (or geometry) of the top outside surface 606 in a complementary way. For example, in the present implementation, the top outside surface 606 is entirely flat (planar) without any additional geometric features, in which case the contact surface 658 may also be entirely flat. In other implementations, however, one or more regions of the top outside surface 606 may not be entirely flat. For example, all or part of the top outside surface 606 may be bent or curved or include additional edges or corners (e.g. steps, shoulders, etc.). In these latter cases, the contact surface 658 of the heated stamp 664 may be complementarily shaped to conform to the not-flat shape of the top outside surface 606.

During the application of the heat and force/pressure, the heated stamp 664 (in particular, the contact surface 658) may be brought into contact with the top outside surface 606 of the intermediate structured substrate 648 cither directly or indirectly. For example, it may be found that the thermoplastic material selected for the substrate body 646 tends to stick to the heated stamp 664 during the fixing process. This problem may be addressed by positioning a sheet 662 between the heated stamp 664 and the substrate body 646, as illustrated in FIG. 6D. The sheet 662 is composed of a thermally conductive, non-stick material effective to transfer the heat and force from the heated stamp 664 to the top outside surface 606 while preventing the thermoplastic material from sticking to the (contact surface 658 of) the heated stamp 664. Examples of materials suitable for use as the sheet 662 include, but are not limited to, PTFE, PI, polydimethylsiloxane (PDMS), ceramic, etc. In this implementation, the sheet 662 is first positioned on the top outside surface 606 and the heated stamp 664 is then pressed onto the sheet 662. In other words, the heated stamp 664 applies the heat and force/pressure to the top outside surface 606 via the sheet 662. In an implementation, the sheet 662 is a temporary component of the fixing process. That is, after removing the heated stamp 664, the sheet 662 also is removed and not retained on the top outside surface 606 as part of the end product.

Alternatively or additionally, the capillaries 104 may be coated with a thermally conductive, non-stick material such as those noted above, in which case a separate non-stick sheet 662 may not be needed.

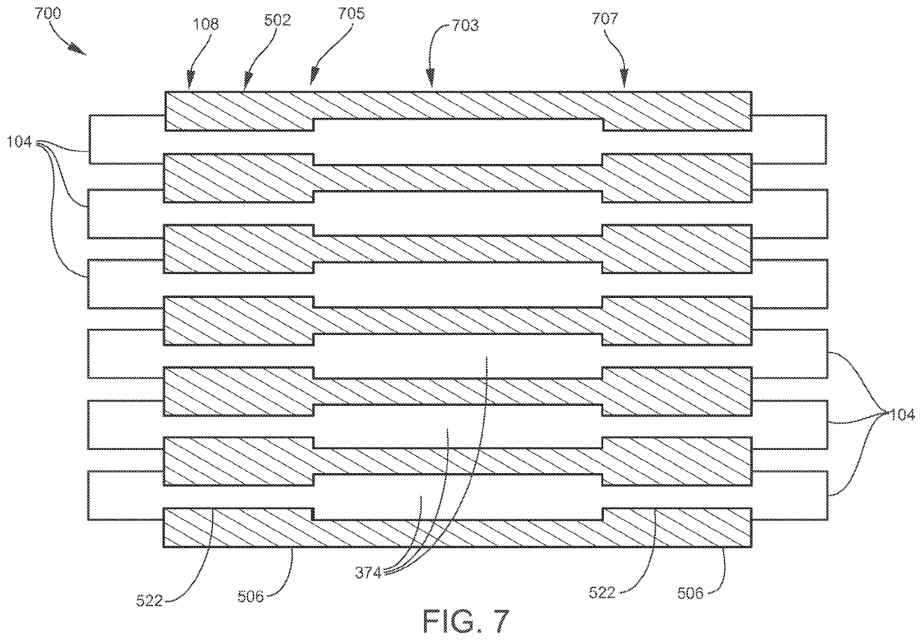

FIG. 7 is a top plan view of an example of a capillary array assembly 700 (or a portion thereof) according to another implementation of the present disclosure. The capillary array assembly 700 may be generally configured in the same manner as the capillary array assembly 100 described above and illustrated in FIGS. 5A-5D. In the implementation shown in FIG. 7, the capillary array assembly 700 is configured for use as a detection cell. For this purpose, the capillary array assembly 700 includes an optical detection area (or windowed section) 703 positioned between two embedded areas 705 and 707. In the optical detection area 703, the capillaries 104 are bare and exposed to the ambient outside the capillary array assembly 700. In other words, the optical detection area 703 is at least partially defined by capillary windows 374 as described above in conjunction with FIG. 3B. In the optical detection area 703, on at least the illustrated top side of the capillary array assembly 700, all or a significant part of the capillary windows 374 are unobscured by the substrate 502, thereby enhancing light transmission with the optical detection system of an associated CE instrument (see, e.g., the description above relating to FIG. 1). On the other hand, in the adjacent embedded areas 705 and 707, the capillaries 104 may be fixed by (at least partial) embedding by the substrate 502 in the manner described above in conjunction with FIGS. 6A-6D.

The presently disclosed subject matter, such as the fixtures 108 and fabrication methods as described herein, may provide one or more advantages. The fabrication method may be highly reproducible, easily automatable, and inexpensive relative to known methods. The fixture 108 provides a segment of embedded capillaries 104 that may be highly miniaturized. The fixture 108 provides a sealed interface between each capillary 104 and the surrounding substrate material, thereby allowing efficient heat transfer and preventing fluid migration into the interface. The fixture 108 does not require the use of adhesives (glues) and thus avoids the disadvantages attending the use of adhesives such as noted above in the Background section. Such disadvantages may include, for example, compatibility of materials with the adhesive (e.g., glueability of materials), additional space requirements (e.g., which limit the packing density of the capillaries 104), unwanted fluorescence, operator dependency on the use of adhesives in the fabrication/assembly of the fixture 108, high dependence on surface quality/cleanliness of surfaces to be contacted by an adhesive, unwanted movement of the capillaries 104 (e.g., due to effects of capillary forces, surface adhesion, dilation or swelling of the adhesive, etc.) while the adhesive is curing, etc. With an adhesiveless/glueless process, flexibility in the design of the fixture 108 is enhanced because the fixture 108 does not require any specific areas, features, or surfaces dedicated for gluing. Hence, the presently disclosed subject matter makes possible more variations in the configuration of the fixture 108, including more types of features and more types of materials. Non-glueable materials may be utilized such as, for example, PTFE, PP, PI, fluoropolymers such as perfluoroalkoxy alkane (PFA), etc. Moreover, in a given implementation, it may be desirable to provide a coating on one or more surfaces of the fixture 108 such as, for example, a PTFE coating, diamond-like carbon (DLC) coating, anti-static coating, etc. The presently disclosed subject matter allows for a wider variety of coatings to be added as there is no requirement for compatibility with an adhesive/glue.

It will be understood that terms such as “communicate” and “in . . . communication with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate with a second component is not intended to exclude the possibility that additional components may be present between, and/or operatively associated or engaged with, the first and second components.

It will be understood that various aspects or details of the invention may be changed without departing from the scope of the invention. Furthermore, the foregoing description is for the purpose of illustration only, and not for the purpose of limitation—the invention being defined by the claims.

What is claimed is:

1. A method for fabricating a capillary array assembly, the method comprising:
providing a substrate composed of a thermoplastic material, the substrate comprising a substrate length, a substrate width, a substrate height, a top outside surface, and a plurality of grooves,
wherein the grooves run along at least part of the substrate length, extend from the top outside surface into the substrate along the substrate height, and are spaced from each other along the substrate width;
inserting a plurality of capillaries into the grooves, respectively; and
fixing the capillaries to the substrate by:
applying heat and force to the substrate for a fixing time effective to displace a portion of the substrate over the capillaries; and
after the fixing time, removing the heat and force to stop the displacing,
wherein, after the fixing, the displaced portion of the substrate hardens and at least partially overlies the capillaries such that the substrate at least partially embeds the capillaries.

2. The method of claim 1, wherein the providing of the substrate comprises forming the grooves.

3. The method of claim 1, wherein the substrate has a configuration according to at least one of:
the substrate is a single-piece body;
the substrate is a non-laminated body.

4. The method of claim 1, wherein the fixing is done according to at least one of:
the fixing is done without adding additional material to the substrate;
the fixing is done without adding additional material to the capillaries;
the fixing is done without utilizing an adhesive.

5. The method of claim 1, wherein the capillaries each comprise an outermost capillary surface, and after the fixing, the substrate directly contacts the outermost capillary surface.

6. The method of claim 5, wherein, for each capillary, the outermost capillary surface is defined by one of:
a bare outside surface of the capillary;
an outer protective layer coaxially surrounding at least a section of the capillary;
an outer protective layer coaxially surrounding at least a section of the capillary and at least partially extending outside the substrate;
an additional outer layer coaxially surrounding at least a section of the capillary, wherein the additional outer layer comprises an electrically conductive material or a thermally conductive material;
an additional outer layer coaxially surrounding at least a section of the capillary and at least partially extending outside the substrate, wherein the additional outer layer comprises an electrically conductive material or a thermally conductive material;
an additional outer layer coaxially surrounding at least a section of the capillary, wherein the additional outer layer comprises a thermally conductive, non-stick material.

7. The method of claim 1, wherein the grooves each have a bottom groove surface, the grooves each have an initial groove height defined between the bottom groove surface and the top outside surface prior to the fixing, and the initial groove height is greater than an outside diameter of the capillaries.

8. The method of claim 7, wherein the initial groove height is in a range of 125% to 200% of the outside diameter of the capillaries.

9. The method of claim 1, wherein the substrate comprises a plurality of groove dividers defining the grooves, the applying of heat and force comprises applying the heat and force to at least portions of the groove dividers, and the displaced portion of the substrate that at least partially overlies the capillaries comprises at least portions of the groove dividers.

10. The method of claim 1, wherein the applying of heat and force comprises pressing a heated stamp onto the top outside surface.

11. The method of claim 10, wherein the top outside surface comprises a non-flat shape, and the heated stamp comprises a contact surface shaped to conform to the non-flat shape.

12. The method of claim 10, comprising, before the pressing, positioning a sheet between the heated stamp and the top outside surface, wherein the sheet is composed of a thermally conductive, non-stick material effective to transfer the heat and the force from the heated stamp to the top outside surface.

13. The method of claim 12, comprising, after the pressing, removing the sheet.

14. The method of claim 1, wherein the capillaries each have an outside diameter in a range from 50 μm to 400 μm, and an inside diameter in a range from 0.5 μm to 200 μm.

15. The method of claim 1, wherein, after the fixing, the capillaries are spaced from each other along the substrate width by a capillary spacing, and the capillary spacing is selected from the group consisting of:
an outside diameter of the capillary plus 30 μm, wherein the outside diameter is in a range from 50 μm to 400 μm;
an outside diameter of the capillary plus 30 μm or greater, wherein the outside diameter is in a range from 50 μm to 400 μm; and
in a range from 100 μm to 600 μm.

16. The method of claim 1, wherein the fixing forms a plurality of slots running along at least part of the substrate length, and the capillaries are exposed to the top outside surface by the slots, respectively.

17. The method of claim 1, wherein:
the capillaries cach have a lower capillary half and an upper capillary half defining a cross-section of the capillary in a transverse plane defined by the substrate width and the substrate height;
after the fixing, the lower capillary half is fully embedded by the substrate; and
after the fixing, the upper capillary half is at least partially embedded by the substrate.

18. The method of claim 1, wherein:
the capillaries comprise capillary windows, respectively;
the capillaries are covered by outer protective layers, respectively, except at the capillary windows; and
the capillary windows are positioned in the substrate in alignment with each other, and are exposed to an environment outside the substrate.

19. The method of claim 1, wherein, after the fixing, along at least a portion of the substrate length, the displaced portions fully overlie the capillaries such that the substrate fully embeds the capillaries.

20. A capillary array assembly, fabricated according to the method of claim 1.
